(19) United States
(12) Patent Application Publication
(10) Pub. No.: US 2006/0260308 A1
(43) Pub. Date: Nov. 23, 2006

(54) Toroidal intersecting vane gas management system

(76) Inventor: Eric Ingersoll, Cambridge, MA (US)

Correspondence Address: ELMORE PATENT LAW GROUP, PC, 209 MAIN STREET, N. CHELMSFORD, MA, 01863, US

(21) Appl. No.: 11/397,658

(22) Filed: Apr. 4, 2006

Related U.S. Application Data
(63) Continuation-in-part of application No. 11/099,217, filed on Apr. 5, 2005.

(51) Int. Cl. F02D 23/00

(52) U.S. Cl. 60/602

(57) ABSTRACT

The invention relates to the discovery that employing a toroidal intersecting vane machine (TIVM) within the internal combustion engine provides substantial improvements in controlling pressure, air pressure and air flow into an engine, while maintaining a simplified mechanical system and providing a compressor with little or no parasitic load on the engine. This invention covers the use of the TIVM for the purpose of providing this control.

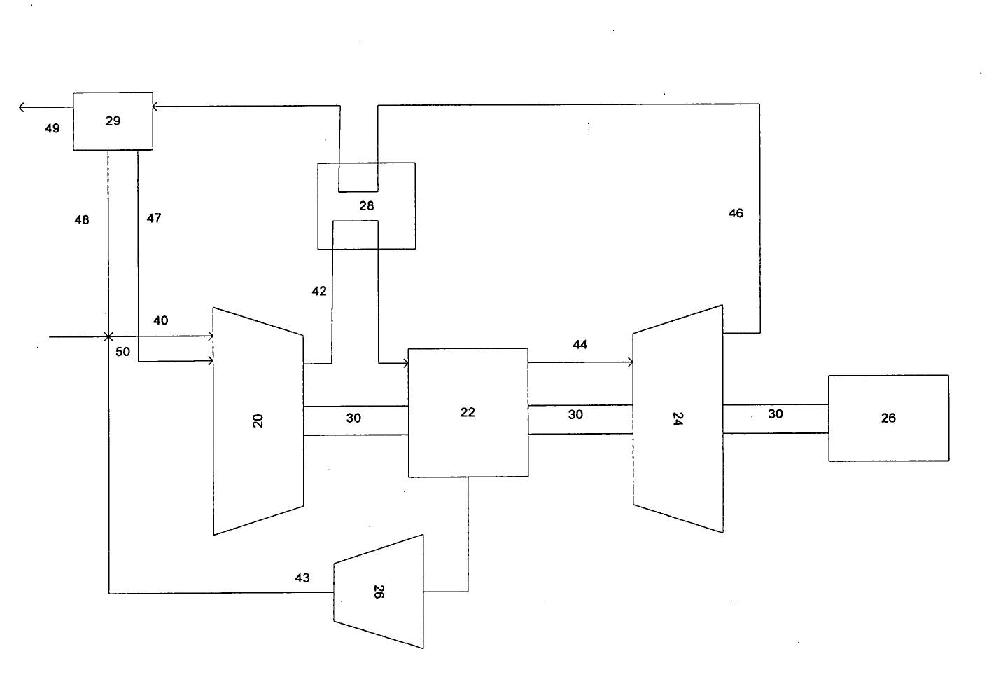

### RELATED APPLICATIONS

This application is a continuation-in-part of U.S. application Ser. No. 11/099,217, filed on Apr. 5, 2005. The entire teaching of the above application is incorporated herein by reference.

### BACKGROUND OF THE INVENTION

As internal combustion engine (ICE) technologies progress, there is an emerging need for greater control over their inputs and output which allows for greater efficiency, performance, and cleaner emissions. Many advances have been made in fuel injection technologies, for example, which have allowed for finer and more precise spray patterns and pressures. There have also been advancements in the use of electronic engine management control systems which utilize digital computer technologies to read and react to various electronic sensors and conditions. Much less advancement, however, has been made regarding the control of intake and exhaust fluids for the engine.

Others have sought to address certain aspect of these needs. More particularly turbochargers and superchargers have been used as methods of controlling the volume and pressure of fluid into the intake lines of internal combustion engines. Turbochargers are described in U.S. Pat. No. 6,854,272 and U.S. Ser. No. 60/559,010 to Kopko, for example, which are incorporated herein by reference. The turbocharger comprises a compressor, which is arranged in the induction system of the internal combustion engine and is connected by means of a shaft to an exhaust gas turbine located in the exhaust system of the internal combustion engine, which exhaust gas turbine is driven by the exhaust gases, of the internal combustion engine, which are at an increased exhaust gas back pressure. The compressor then induces ambient air (and or other gasses) and compresses the latter to an increased boost pressure, at which the combustion air is supplied to the internal combustion engine. A supercharger is a compressor, fulfilling the same function as a turbocharger, but driven mechanically by the engine.

Exhaust Gas Recirculation (EGR) pumps and control valves, Primary Crankcase Ventilation (PCV) valves and systems, and external air pumps are also examples of various separate systems that have been used to address individual components of the problem.

However each of these approaches suffers from one or more of the following disadvantages: they are limited in the ranges of pressures they can produce, they are unable to supply both pressurized and expanded fluid or fluids of various pressures for a plurality of needs in a single instance, they are limited in form factor and placement, they are unable to operate at a rotational speed which equals that of the internal combustion engine, nor can they produce a constant predetermined pressure at any of the variable rotational speeds within their operational range.

For the foregoing reasons there remains a need for a compact, efficient, adaptable, multi-configurable fluid control and management system capable of consolidation into a system for internal combustion engines.

### SUMMARY OF THE INVENTION

The invention relates to a supercharger and turbocharger for an internal combustion engine. Specifically, the invention relates to the use of a Toroidal Intersecting Vane Machine (TIVM) for the control of gas and air, or more generally fluids, into and out of an internal combustion engine and the placement of TIVMs into the fluid flow which are capable of pumping, compressing, or expanding the relevant fluids as needed. The present solution may be applied to all manner and types of internal combustion engines, be they reciprocating, rotary, linear, or free piston for example, regardless of fuel type. It is known that TIVMs are capable of efficiently pumping, compressing and/or expanding fluids passed through them and TIVM function and design are disclosed in U.S. Pat. Nos. 6,901,904 and 5,233,954 both of which are incorporated herein by reference.

To this end, it is desirable to have extensive control over the pressure and amount, i.e. volume, temperature and the composition of intake gasses, such as air flowing into an engine and of various exhaust gases out of the engine, to exercise this control while maintaining as simple a mechanical system as possible and to increase and control the pressure of the air going into the engine. Furthermore, it is also desirable to be able to drive the compressor and or expander making this compressed air with little or no parasitic load on the engine. It is also desirable to boost the pressure of the air entering the engine at low rpm. This is difficult for turbochargers, and is one of the reasons superchargers are used instead.

As engine developers and packagers use increasingly more sophisticated and turbo-machinery to affect this control, the systems are also growing in complexity. There exists a need to meet these objectives, yet avoid complex systems. Therefore, the primary objective of the present invention is to control ICE internal gas pressures and temperatures without taking power from the system or adding undue complexity.

The invention relates to the discovery that employing a toroidal intersecting vane machine (TIVM) within and/or in conjunction with the internal combustion engine provides substantial improvements in controlling pressure, air pressure and air flow into and out of an engine, while maintaining a simplified mechanical system and providing a compressor with little or no parasitic load on the engine. This invention covers the use of the TIVM for the purpose of providing this control.

The benefits of this invention include:

(1) better match between the output pressure from the supercharger and the boost pressure desired for the engine over the full operating range of the engine. Unlike other solutions which are only able to provide fixed levels of pressure at any given point in the operating range regardless of load values or other parameters, the use of a toroidal intersecting vane machine as a compressor (TIVC) allows for the production of a wider range of pressures and multiple pressures at any given point in the operating range allowing a better match to engine needs. These pressure may range from about 0.5 atm to 2 atm for an average consumer automobile use, between 3 and 6 atm for more demanding power needs, and between 7 and 10 atm or greater for some newer internal combustion technologies or alternative fuel uses, for example.

(2) reduced power requirement for the same mass flow (as compared with existing superchargers). The mass which flows may comprise gases, air, fuels, water or fluid-like elements or combinations thereof.

(3) excellent transient response characterized by the production of a near linear pressure output which begins at very low rotational speed. A TIVM capable of producing full pressure needs at the speeds at which many internal combustions engines idle, such as about 300 to about 800 rpm of the main output shaft, affords the availability of full pressure at any point in the operating range of engine.

(4) the ability to pump multiple gases with the same compressor at the same or varying pressure ratios (thereby providing improvements in exhaust gas recirculation and pumping or evacuating crankcase gases, moving coolants, fuels, or other fluid utilized by the engine or peripheral systems). This allows simultaneous control of the fluid needs of the engine.

(5) good to excellent match between the operating RPM (rotations per minute; a measure of rotational speed) of the compressor and the RPM of the engine. This may include a 1:1 ratio, if desired. The TIVM when used as a compressor, TIVC, is capable of functionally operating within the same operational speed ranges of most internal combustion engines. These rotational speeds are usually about 200 to about 20,000 rotations of the main crank per minute.

(6) good to excellent match between the RPM of the expander and the RPM of the engine. The TIVM when used as an expander, TIVE, is also capable of functionally operating within the same operational speed ranges of most internal combustion engines. These rotational speeds are usually about 200 to about 20,000 rotations of the main crank per minute.

(7) the ability to mount the compressor and/or expander on the main crankshaft of the engine. This is made possible because both may operate at the same rotational speed.

(8) the ability to vary the pressure ratio of the compressor and expander to match engine requirements over a broad operating range and the ability to configure the compressor or expanded into multiple stages of compression.

(9) the ability to employ higher pressure ratios than can be achieved with traditional super- or turbo-machinery, which are usually limited to produce pressures of about 1.5 to about 2.5 atmospheres (atm) of output. As such, employing a TIVM allows for pressures as high as about 10 atm or greater to be produced.

(10) the ability to further increase engine efficiency through a turbo compound arrangement, for example.

The invention, therefore relates to internal combustion engines, such as supercharged internal combustion engines, that employ one or more toroidal intersecting vane machines to provide air flow, air compression and/or air expansion in combination with a combuster. Further, the present invention is not limited to the control or management of solely gas and air, but to the management of fluids which may comprise elements of gas, air, fuels, water or other fluids, combinations thereof or components having fluid-like properties.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

The FIGURE is a block diagram of an internal combustion engine system according to the invention.

### DETAILED DESCRIPTION OF THE INVENTION

The invention relates to an internal combustion engine system comprising a toroidal intersecting vane machine (compressor and/or expander) in combination with a combuster. In a preferred embodiment, the invention comprises an internal combustion engine comprising a combuster (such as one or more cylinders, each cylinder providing a combustion chamber and one or more fuel delivery systems (such as injectors) in communication with said cylinder(s), capable of injecting fuel into each said combustion chamber); an air intake line operatively connected to the combuster and to a toroidal intersecting vane compressor, to provide compressed air to the combustion chamber(s) from the compressor; an exhaust line also operatively connected to the combuster, to receive exhaust gas from the combustion chamber(s); and a main crank shaft functionally attached to and driven by said combuster.

In one embodiment, the invention comprises an internal combustion engine comprising a combuster (such as one or more combustion chambers; one or more fuel delivery systems such as a nozzle, a fuel injector or carburetor, in communication with said combuster, capable of injecting fuel into each said combustion chamber; an air intake line operatively connected to the combuster; an exhaust line also operatively connected to the combuster, to receive exhaust gas from the combustion chamber(s); a main shaft functionally attached to and repeatedly driven by said combuster; and to a toroidal intersecting vane compressor, configured to control the flow of compressed fluid to the combustion chamber(s).

The FIGURE illustrates the embodiment of the invention. Air is provided to the compressor 20 via an intake line 40 and exits the system via an export line 49. The air can be fresh air or recirculated air, as can be provided from crankcase gas or exhaust, or some combination thereof (or other sources). Further, the air can be provided at atmospheric pressure or compressed (e.g. via a toroidal intersecting vane machine) to pressure of about 1.5 to about 10 atm, and may be at ambient temperature, that is being at or about equal to the surrounding environmental temperature, heated to a temperature higher than the ambient temperature (as can occur upon compression) or cooled to a temperature lower than the ambient temperature (e.g., via a heat exchanger or regenerator). One of the benefits of the TIVM in this regard is the flexibility of the compressor to suit the needs of the specific application.

One of ordinary skill will understand that the present invention can be used to manage fluids located within an ICE, known in the art to include air and gas as these substances have fluid properties. Throughout this document the term fluid follows it normal usage as meaning any continuous, amorphous substance whose molecules move freely past one another and that has the tendency to assume the shape of its container; a liquid or gas or combination thereof, such as air. Preferred fluids include air, gas and/or exhaust. In the following embodiments, it will be understood that other fluids can be used in place air, gas and/or exhaust, as will be understood in the art.

The compressor 20 is preferably a toroidal intersecting vane machine (TIVM). Toroidal intersecting vane machines suitable for use in the invention include those described in U.S. application Ser. No. 10/744,230, filed on Dec. 22, 2003, which is incorporated herein by reference. In particular, the TIVM comprises a first rotor and at least one intersecting secondary rotor, wherein:

(a) said first rotor has a plurality of primary vanes positioned on a radially inner peripheral surface of said first rotor, with spaces between said primary vanes and said inside surface of said supporting structure defining a plurality of primary chambers;

(b) an intake port which permits flow of air into said primary chamber and an exhaust port which permits exhaust of compressed air out of said primary chamber;

(c) said secondary rotor has a plurality of secondary vanes positioned on a radially outer peripheral surface of said secondary rotor, with spaces between said secondary vanes and said inside surface of said supporting structure defining a plurality of secondary chambers;

(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and

(e) wherein the secondary vanes positively displace the primary chambers and pressurize the air in the primary chambers.

In another embodiment, the above rotors are configured to permit the primary vanes to positively displace the secondary chambers and pressurize air in the secondary chambers.

An advantage in using the TIVM as the compressor (TIVC) in the invention lies in the great flexibility of the rotation speeds of the TIVM in producing a targeted pressure or ratio of compression. Thus, compressor rotation speeds approximating the rotation speed of the main crank shaft of the combuster are possible. In one embodiment, if the TIVM acts as a compressor (TIVC) and is driven by a crank or by an external means, then a supercharger is created. If, on the other hand, the compressor is driven by exhaust pressure, a turbocharger results. In the latter instance, the main shaft would not be a crank shaft but simply a main shaft.

Thus, in one embodiment, the system includes one or more superchargers 29, such as a supercharger described in U.S. Ser. No. 60/559,010 to Kopko, which is incorporated herein by reference in its entirety. It is particularly preferred that such superchargers employ TIVMs as the compressors and/or expanders. In the embodiment, the toroidal intersecting vane compressor 20 further comprises a compressor rotor shaft 30 through the axis of rotation of the first rotor wherein the compressor rotor shaft 30 drives the compressor 20 and/or the compressor rotor shaft 30 is the main shaft 30 or is functionally driven directly by the main shaft 30 possibly through a gear or coupling, or indirectly through the use of belt or chain, for example, operatively connected to the rotating shafts, thereby permitting the main shaft 30 (e.g., via the combuster 22) to drive the compressor. This configuration permits efficiency in engine size, and orientation. It may be desirable in some embodiments of the invention to add a speed reducer or speed increaser to provide optimal turning speeds for the compressor and main crankshaft. Suitable examples might be gears or pulleys of differing sizes which allow for coupling at differing rotational speeds whose ratios equal the ration of the size difference of the gears or pulleys.

The TIVM preferably has a plurality of secondary rotors which can be configured to provide multi-stage compression (achieved by directing the pressurized exhaust from one chamber into a second or subsequent chamber to be further compressed), as described in PCT/US2003/42904 filed on Dec. 21, 2004. In another embodiment, the compressor, characterized by a plurality of secondary rotors, can be configured to produce compressed intake air at two or more distinct pressure ratios, in series or in parallel. The instant invention contemplates applications which may utilize up to ten secondary rotors and then produce fluid at ten differing pressures. These pressures can be outputted and directed to engine needs, or routed within the TIVM to another stage for further compression. Where the compressor is a multi-stage compressor or where two or more compressors are employed, efficiency can be further effected by cooling the air between compression stages.

It is common practice to compress air to pressures between about 1.5 atm and 2 atm for gasoline internal combustion engines and up to about 3 atm in larger or diesel internal combustion engines. This invention contemplates compressing the air (or other intake gas) to such pressures. Higher pressures can also be advantageously achieved. For example the TIVC can compress intake air to between about 2 to about 10 atm. Optionally, the TIVC has a rotation speed of matching the common rotational speeds of internal combustion engines, for example about 200 to about 20,000 rotations per minute.

In one embodiment, the compressor 20 can be attached to and driven by an electric motor or generator 26 which can be conveniently mounted on or attached to the main crank shaft 30. As such the compressor may also drive the main crank shaft. This permits start-up and control of the compressor independent from the combuster. Alternatively, the compressor and/or expander and/or generator, discussed herein, can be attached to a shaft other than the main crank shaft. These include, for example, drive shafts, transmission shafts, cam shafts or any secondary or accessory output shaft.

In another example, current and emerging hybrid automobiles often employ a combination of small and efficient internal combustion engines, electric motors, and electric generators, and often shift power output between these devices. In such a system, the present invention contemplates that the TIVC may be functionally attached to and driven by any one or more of the components listed.

Compressed air exits the compressor via line 42, through an optional intercooler or regenerator 28 to cool the compressed and, thereby heated, air. The compressed air is directed to the combuster 22. The combuster 22 can be a typical combuster, such as one having one or more cylinders with a combustion chamber and one or more fuel supply systems in communication with said cylinder(s), capable of injecting fuel into each said combustion chamber such as an electronic fuel injection or carburetion type system, or a diesel type fuel nozzle. The fuel can then be combusted (e.g., by compression by ignition or other means). The combustion produces work, e.g., by rotating the main crank shaft 30. Exhaust gases are then directed from the combuster via exhaust line 44.

The system of the invention can further comprise, in addition or as an alternative to the toroidal intersecting vane compressor, a toroidal intersecting vane expander 24 operatively connected to exhaust line 44. Like the TIVC, the toroidal intersecting vane expander (TIVE) can comprise a first rotor and at least one intersecting secondary rotor, wherein:

(a) said first rotor has a plurality of primary vanes positioned on a radially inner peripheral surface of said first rotor, with spaces between said primary vanes and said inside surface of said supporting structure defining a plurality of primary chambers;

(b) an intake port which permits flow of exhaust gas into said primary chamber and an exhaust port which permits exhaust of expanded exhaust gas out of said primary chamber;

(c) said secondary rotor has a plurality of secondary vanes positioned on a radially outer peripheral surface of said secondary rotor, with spaces between said secondary vanes and said inside surface of said supporting structure defining a plurality of secondary chambers;

(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and

(e) wherein the primary vanes positively displace the secondary vanes and expand the exhaust gas in the primary chambers.

In another embodiment, the above rotors of the TIVE are configured to permit the primary vanes to positively displace the secondary chambers and pressurize gas in the secondary chambers.

In another embodiment, the above rotors of the TIVE are configured to permit the primary vanes positively displace the secondary vanes and expand the exhaust gas in the primary chambers.

In another embodiment, the above rotors of the TIVE are configured to permit the primary vanes positively displace the secondary chambers and pressurize fluid in the secondary chambers.

Like the TIVC, an advantage in using the TIVM as the expander in the invention lies in the great flexibility of the rotation speeds of the TIVM in producing a targeted pressure or expansion ratio. Thus, expander rotation speeds approximating the rotation speed of the main crank shaft of the combuster are possible. Thus, in one embodiment of the invention, the toroidal intersecting vane expander 24 further comprises an expander rotor shaft 30 through the axis of rotation of the first rotor wherein the expander rotor shaft 30 is driven be the expander 22 and/or the expander rotor shaft 30 is the main crank shaft or is functionally connected to and acts upon the main crank shaft 30. This configuration permits efficiency in engine size and communication between the rotating shafts, thereby permitting the main crank shaft 30 to be further driven by the expander and/or to drive the compressor. It may be desirable in some embodiments of the invention to add a speed reducer or speed increaser such as gears or pulleys to provide optimal turning speeds for the expander and main crankshaft.

The TIVM preferably has a plurality of secondary rotors which can be configured to provide multi-stage expansion (achieved by directing the expanded exhaust from one chamber into a second or subsequent chamber to be further expanded), as described in PCT/US2003/42904 filed on Dec. 21, 2004.

In another embodiment, the expander, characterized by a plurality of secondary rotors, can be configured to produce expanded intake air at two or more distinct pressure ratios, in series or in parallel. Where the expander is a multi-stage expander or where two or more expanders are employed, efficiency can be further affected by heating the air between expansion stages. For example, the cooled air resulting from expansion can be directed to an intercooler or regenerator 28 via exhaust line 46 and used to cool the heated compressed air in line 42, for example allowing the charge air for the engine to be cooled below ambient temperature.

In another embodiment, the cooled air coming from the intercooler 28 can be further expanded (e.g., through the TIVE) to provide cooling to the engine, reducing peak combustion temperatures, increasing power density (mass air flow) and reducing compression work in the cylinder. It is often desirable to expand the exhaust gas to ambient pressure or the pressure of the intake air line 40.

The expander 24 can be attached to and drive, or be driven by, a generator 26, which can be conveniently mounted on or attached to the main crank shaft 30. For example, current and emerging hybrid automobiles often employ a combination of small and efficient internal combustion engines, electric motors, and electric generators, and often shift power output between these devices. In such a system the TIVE may be functionally attached to and drive any one or more of the components listed.

Exhaust Gas Recirculation (EGR) systems have been used to reduce emissions of nitrogen oxides (NOx) from gasoline engines for almost 20 years. Basically, they work by recirculating exhaust gases back into the intake stream, which cools the combustion process and, thereby, reduces NOx formation. Because of tightening NOx standards, more advanced EGR systems are being developed for use in almost all engines. However, the use of EGR for many types of engines, especially for engines that function at lower temperatures such as diesels, presents several challenges including insufficient differential pressure across the EGR line, which leads to a low flow rate of recirculated gases.

In a particularly preferred embodiment, at least a portion of the exhaust gas from the combuster is directly or indirectly (e.g., via the expander 24) introduced into the air intake line 40 of the system. This can be accomplished by, for example, directing a recirculation line 48 of a portion of said exhaust gas to said air intake line 40. A flexible corrugated line resistant to high temperature is desired for such a use. An EGR control valve 50 operated so as to control the concentration of recirculated exhaust gas and air can be advantageously added. Typically, between 10% and 30% of the total intake gas directed into the compressor 20 is recirculated exhaust gas but as much as about 70% of the total intake gas to be directed into the compressor 20 may be recirculated. Here the TIVM is able to overcome the expressed limitation by providing a nearly constant differential pressure across the EGR line.

In yet another embodiment, exhaust gas can be directed to the compressor prior to mixing with the intake air via line 47. In this embodiment, one or more rotors of the TIVC can be dedicated to compressing exhaust gas independently of compressing air. The compressed exhaust gas and air can be subsequently mixed for combustion. Thus, by way of example, two or three rotors can compress exhaust while six or more rotors can compress air. This embodiment provides an alternative method for controlling recirculation.

The system can include a controller (e.g., a computer or mechanical) that controls at least one of: the quantity of fuel injected, the quantity of recirculated exhaust gas, the quantity of air, the pressure of recirculated exhaust gas, and/or the pressure of air or any combination thereof. It is further preferred for such control systems to be part of the primary engine control module (ECM) such as are commonly used in the art.

During normal compression within many internal combustion engines a small amount of gases from the combustion chamber escape past the piston seal. Approximately 70% of these “blow-by” gases are unburned fuel hydrocarbons that may dilute and contaminate the engine oil, cause corrosion of critical parts, and contribute to sludge buildup within the crankcase. At higher engine speeds blow-by gases may increase crankcase pressure enough to cause oil leakage from sealed engine surfaces. This problem is even greater in a forced induction system where crankcase pressures are exponentially elevated. The purpose of the PCV system is to remove these harmful gases from the crankcase before damage occurs and combine them with the engine intake charge so they can be burned in the normal combustion process. Current common practice is to use positive manifold pressure to evacuate these gases. However, pressure from the manifold is not always sufficient or consistent enough to fully evacuate the crankcase.

In yet another embodiment, crankcase gas can be removed from the combuster and recirculated via line 43 to intake air line 40. As such, a TIVM may be employed to more efficiently and fully evacuate these gases and redirect them as necessary. This gas can be advantageously pumped via a TIVC 26, as described herein. Indeed, combination of the TIVC 20 and TIVC 26 and/or the TIVE 24 into a single TIVM providing a single machine that manages multiple (or all) gas flow within the engine or system is possible. Furthermore, it has been found that positively evacuating the crankcase gases can advantageously create negative pressure on the backside of the pistons of many internal combustion engines, which in turn further reduces the amount of energy required to move said piston downward. Utilizing the TIVM for this purpose can lead to greater efficiency and improved engine performance.

Alternative embodiments of the invention include insertion of by-pass valves into the intake air line 40 that permit avoiding or reducing supercharging, i.e. reducing the compression of intake gas when it is unnecessary. Standard industry pressure release or blow off valves, diverter valves and waste gates may be employed as appropriate.

To control unwanted heat in the system, an additional embodiment includes the use of external cooling methods to reduce the temperature of the TIVM and its corresponding output accordingly. Said embodiment may utilize an already existing engine cooling system and its relevant cooling fluids which flow through a heat exchanger, such as an automotive radiator, and are then channeled through the body of the TIVM, or a separate fluid or air based system as appropriate for the particular application.

In another embodiment the compressed air coming from the TIVM when used as a compressor exits the compressor via line 42 and is directed to a reservoir for storage and later use within the internal combustion engine system. In this embodiment the TIVM may be driven by any of the methods described above including possibly any one of the following; the main shaft, the expander rotor shaft, an electric motor, or a rotating shaft on the engine other than the main shaft, or by some other method which will operatively rotate the rotor shaft. The resulting pressurized gas is routed to a reservoir where it is stored until needed for further use. Such uses may include routing to the input air which is outputted at a consistent and fixed high pressure and injected into the exhaust gas stream possibly by direct injection into a catalytic converter for emission control and or particulate control. Similarly said output might be directed to the air intake stream for use in a compression ignition engine such as a Diesel, or Homogenous Charged Compression Ignition system (HCCI) or any of its evolving variants. HCCI engines have the potential to provide high, diesel-like efficiencies and very low emissions. (See Robert W. Dibble, Michael Au, James W. Girard, Salvador M. Aceves, Daniel L. Flowers, Joel Martinez-Frias, “A Review of HCCI Engine Research: Analysis and Experiments”, SAE Paper 2001-01-2511). In an HCCI engine, a dilute, premixed fuel/air charge auto-ignites and burns volumetrically as a result of being compressed by the piston. The charge is made dilute either by being very lean, or by mixing with recycled exhaust gases. Additionally, intake pressure boosting may be used for increased power, heat transfer effects, combustion-phasing control, and extending operation to higher loads. Several technical barriers must be overcome before HCCI can be implemented in production engines. A reliable source of consistent and controllable pressurized gas at up to 6 atm as can be provided by a TIVM coupled to the system, is one such barrier which this invention seeks to overcome.

Further embodiments might utilize the reservoir of pressurized air in air-based braking or suspension systems, or other onboard needs.

While this invention has been particularly shown and described with references to preferred embodiments thereof, it will be understood by those skilled in the art that various changes in form and details may be made therein without departing from the scope of the invention encompassed by the appended claims.

What is claimed is:

1. An internal combustion engine system comprising:
(a) a combuster;
(b) one or more fuel supply systems in communication with said combuster, capable of injecting fuel into a combustion chamber;
(c) an air intake line operatively connected to the combuster and to a toroidal intersecting vane compressor, to provide compressed air to the combustion chamber(s) from the compressor;
(d) an exhaust line also operatively connected to the combuster, to receive exhaust gas from the combustion chamber(s); and
(e) a main crank shaft functionally attached to and driven by said combuster.

2. The system according to claim 1, wherein the toroidal intersecting vane compressor comprises a first rotor and at least one intersecting secondary rotor, wherein:
(a) said first rotor has a plurality of primary vanes positioned on a radially inner peripheral surface of said first rotor, with spaces between said primary vanes and said inside surface of said supporting structure defining a plurality of primary chambers;
(b) an intake port which permits flow of air into said primary chamber and an exhaust port which permits exhaust of compressed air out of said primary chamber;
(c) said secondary rotor has a plurality of secondary vanes positioned on a radially outer peripheral surface of said secondary rotor, with spaces between said secondary vanes and said inside surface of said supporting structure defining a plurality of secondary chambers;
(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and
(e) wherein the secondary vanes positively displace the primary chambers and pressurize the air in the primary chambers.

3. The system according to claim 2, wherein the toroidal intersecting vane compressor further comprises a compressor rotor shaft through the axis of rotation of the first rotor wherein the compressor rotor shaft drives the compressor.

4. The system according to claim 3, wherein the compressor rotor shaft is the main crank shaft.

5. The system according to claim 2, wherein the toroidal intersecting vane compressor comprises a plurality of secondary rotors and is configured as a multistage compressor.

6. The system according to claim 5, wherein compressed air is cooled between compression stages.

7. The system according to claim 2, wherein the toroidal intersecting vane machine comprises a plurality of rotors and is configured to produce compressed intake air at two or more distinct pressure ratios.

8. The system according to claim 3, wherein the compressor is functionally attached to and driven by an electric motor.

9. The system according to claim 1 further comprising a toroidal intersecting vane expander operatively connected to said exhaust line.

10. The system according to claim 9, wherein the toroidal intersecting vane expander comprises a first rotor and at least one intersecting secondary rotor, wherein:
(a) said first rotor has a plurality of primary vanes positioned on a radially inner peripheral surface of said first rotor, with spaces between said primary vanes and said inside surface of said supporting structure defining a plurality of primary chambers;
(b) an intake port which permits flow of exhaust gas into said primary chamber and an exhaust port which permits exhaust of expanded exhaust gas out of said primary chamber;
(c) said secondary rotor has a plurality of secondary vanes positioned on a radially outer peripheral surface of said secondary rotor, with spaces between said secondary vanes and said inside surface of said supporting structure defining a plurality of secondary chambers;
(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and
(e) wherein the primary vanes positively displace the secondary vanes and expand the exhaust gas in the primary chambers.

11. The system according to claim 10, wherein the toroidal intersecting vane expander further comprises an expander rotor shaft through the axis of rotation of the first rotor wherein the expander drives the expander rotor shaft.

12. The system according to claim 11, wherein the expander rotor shaft is the main crank shaft.

13. The system according to claim 11, wherein the expander rotor shaft is the compressor rotor shaft.

14. The system according to claim 13, wherein the expander rotor shaft drives an electric generator operationally attached to said compressor.

15. The system according to claim 10, wherein the toroidal intersecting vane expander comprises a plurality of secondary rotors and is configured as a multistage expander.

16. The system according to claim 15, wherein the exhaust gas is heated between expansion stages or the expander is configured to provide cooled air for the engine through expansion of compressed air.

17. The system according to claim 16, wherein the heat from exhaust gas is used to heat compressed air in a heat exchanger.

18. The system according to claim 10, wherein the toroidal intersecting vane machine comprises a plurality of rotors and is configured to produce expanded exhaust gas at two or more distinct pressure ratios.

19. The system according to claim 1 further comprising a line for recirculation of a portion of said exhaust gas to said air intake line.

20. The system according to claim 19 further comprising an EGR control valve operated so as to control the concentration of recirculated exhaust gas and air.

21. The system according to claim 10 comprising a controller to control at least one of the quantity of fuel injected, the quantity of recirculated exhaust gas, the quantity of air, the pressure of recirculated exhaust gas, and/or the pressure of air.

22. The system according to claim 1, wherein the air is compressed to a pressure between about 1.5 and about 2 atm.

23. The system according to claim 22, wherein the compressor rotor shaft rotates at the same speed as the main crank shaft.

24. The system according to claim 23, wherein the air is compressed to a substantially consistent pressure at variable rotation speeds of the compressor rotor shaft.

25. The system according to claim 13, where the compressor and expander are both on the crankshaft.

26. The system according to claim 13, where the compressor and expander are not on the main crankshaft.

27. The system according to claim 1, where the compressor pressure ratio is selected to reduce the compression work of the engine.

28. A system comprising:
(a) a combuster; characterized by having a combustion chamber;
(b) one or more fuel supply systems in communication with said combuster, capable of injecting fuel into the combustion chamber;
(c) a fluid intake line operatively connected to the combuster;
(d) a fluid exhaust line operatively connected to the combuster;
(e) a main shaft functionally attached to and driven by the combuster; and
(f) a toroidal intersecting vane machine operatively connected to the combuster, arranged so as to control fluid flow into and or out of the combuster.

29. The system of claim 28, wherein the fluid is air.

30. The system according to claim 29, wherein the toroidal intersecting vane machine is a TIVC comprising a first rotor and at least one intersecting secondary rotor, wherein:
(a) said first rotor has a plurality of primary vanes positioned on a radially inner peripheral surface of said first rotor, with spaces between said primary vanes and said inside surface of said supporting structure defining a plurality of primary chambers;
(b) an intake port which permits flow of air into said primary chamber and an exhaust port which permits exhaust of compressed air out of said primary chamber;
(c) said secondary rotor has a plurality of secondary vanes positioned on a radially outer peripheral surface of said secondary rotor, with spaces between said secondary vanes and said inside surface of said supporting structure defining a plurality of secondary chambers;
(d) a first axis of rotation of said first rotor and a second axis of rotation of said secondary rotor arranged so that said axes of first rotation do not intersect, said first rotor, said secondary rotor, primary vanes and secondary vanes being arranged so that said primary vanes and said secondary vanes intersect at only one location during their rotation; and
(e) wherein the secondary vanes positively displace the primary chambers and compress the air in the primary chambers.

31. The system of claim 30, wherein the air entering the intake port is recirculated air.

32. The system of claim 31, wherein the recirculated air is provided from crankcase gas or exhaust or some combination thereof.

33. The system according to claim 30, wherein the main shaft is a compressor rotor shaft operatively connected to and forcibly driving the rotation of said first or second rotors or combination thereof.

34. The system according to claim 30, wherein the main shaft is a main crank shaft operatively connected to and forcibly driving the rotation of said first or second rotors or combination thereof.

35. The system according to claim 30, where the exhaust port is operatively connected to the air intake line.

36. The system according to claim 33, wherein the compressor rotor shaft is operatively connected to and driven by the main shaft.

37. The system according to claim 30, wherein the toroidal intersecting vane compressor comprises a plurality of secondary rotors and is configured as a multistage compressor.

38. The system according to claim 37, wherein the temperature of the air is actively lowered between stages.

39. The system according to claim 30, wherein the toroidal intersecting vane compressor comprises a plurality of secondary rotors and is configured to compress air at two or more distinct pressure ratios.

40. The system according to claim 30, wherein the compressor rotor shaft is functionally rotated by an electric motor.

41. The system according to claim 28, wherein the toroidal intersecting vane machine, is a TIVE and comprises a first rotor and at least one intersecting secondary rotor, wherein:
(a) said first rotor has a plurality of primary vanes positioned on a radially inner peripheral surface of said first rotor, with spaces between said primary vanes and said inside surface of said supporting structure defining a plurality of primary chambers;
(b) an intake port which permits flow of fluid into said primary chamber and an exhaust port which permits exhaust of expanded fluid out of said primary chamber, wherein the fluid is exhaust gas;
(c) said secondary rotor has a plurality of secondary vanes positioned on a radially outer peripheral surface of said secondary rotor, with spaces between said secondary vanes and said inside surface of said supporting structure defining a plurality of secondary chambers;
(d) a first axis of rotation of said first rotor and a second axis of rotation of said secondary rotor arranged so that said axes of rotation do not intersect, said first rotor, said secondary rotor, primary vanes and secondary vanes being arranged so that said primary vanes and said secondary vanes intersect at only one location during their rotation; and
(e) wherein the primary vanes positively displace the secondary vanes and expand the exhaust gas in the primary chambers.

42. The system according to claim 41, where the toroidal intersecting vane expander further comprises an expander rotor shaft operatively connected to and driven by the rotation of said first and or second rotors or combination thereof.

43. The system according to claim 41, where the intake port is operatively connected to the exhaust line.

44. The system according to claim 42, wherein the expander rotor shaft is the main shaft.

45. The system according to claim 42, wherein the expander rotor shaft is the compressor rotor shaft.

46. The system according to claim 42, wherein the expander rotor shaft drives an electric generator.

47. The system according to claim 42, wherein the toroidal intersecting vane expander comprises a plurality of secondary rotors and is configured as a multistage expander.

48. The system according to claim 47, wherein the exhaust gas is heated between expansion stages or at least one stage of the expander is configured to provide cooled air through the intake line from the expansion of compressed air.

49. The system according to claim 47, further comprising a heat exchanger, wherein the heat from exhaust gas is used to heat compressed air while in the heat exchanger.

50. The system according to claim 42, wherein the toroidal intersecting vane expander comprises a plurality of rotors and is configured to produce expanded exhaust fluid at two or more distinct pressure ratios.

51. The system according to claim 28, further comprising an exhaust gas recirculation line wherein said line recirculates a portion of the exhaust gas to the air intake line.

52. The system according to claim 51, further comprising an Exhaust Gas Recirculation (EGR) control valve operated so as to control the gas flowing through the exhaust gas recirculation line.

53. The system according to claim 51, further comprising an Exhaust Gas Recirculation (EGR) control valve operated so as to control the concentration of recirculated exhaust gas and air.

54. The system according to claim 51 comprising a controller to control at least one of the quantity of fuel injected, the quantity of recirculated exhaust gas, the quantity of intake air, the pressure of recirculated exhaust gas, and/or the pressure of the intake air.

55. The system according to claim 30, wherein the air is compressed to a pressure between about 0.2 and about 10 atm.

56. The system according to claim 30, wherein the air is compressed to a pressure between about 0.5 and about 6 atm.

57. The system according to claim 30, wherein the air is compressed to a pressure between about 0.7 and about 2 atm.

58. The system according to claim 33, wherein the compressor rotor shaft rotates at substantially the same speed as the main shaft.

59. The system according to claim 58, wherein the air is compressed to a substantially consistent pressure at variable rotation speeds of the compressor rotor shaft.

60. The system according to claim 45, where the compressor rotor shaft and expander rotor shaft are both coupled directly to the main shaft.

61. The system according to claim 30, where the compressor pressure ratio is selected to reduce the compression work of the engine.

62. The system according to claim 28, wherein the toroidal intersecting vane machine comprises a plurality of secondary rotors and is configured such that at least one secondary rotor compresses air while at least one other secondary rotor expands air.

63. The system according to claim 28, further comprising a crankcase fluid ventilation port.

64. The system according to claim 61, where the intake port is operatively connected to the crankcase fluid ventilation port.

65. The system according to claim 28, further comprising a cooling system, wherein said cooling system is used to lower the temperature of the toroidal intersecting vane machine.

66. The system according to claim 30, where the compressed air is directed to and stored in a remote reservoir.

67. The system according to claim 66, where at least some of the stored air is released and directed to at least one of the inputs selected from the group consisting of the Exhaust Gas Recirculation valve, the gas exhaust stream, the air intake stream, and a peripheral mechanical device outside the system.
